(19) United States
(12) Patent Application Publication
(10) Pub. No.: US 2013/0160503 A1
(43) Pub. Date: Jun. 27, 2013

(54) Apparatus and Methods for Restricting Access to a Gas Source

(71) Applicant: The Rectorseal Corporation, Houston, TX (US)

(72) Inventors: Robert Martinelli, Katy, TX (US); Zheng-Yi Xu, Houston, TX (US); Michael A. Moore, Dighton, MA (US); Harvey Steven Grodjesk, Houston, TX (US)

(73) Assignee: THE RECTORSEAL CORPORATION, Houston, TX (US)

(21) Appl. No.: 13/741,885

(22) Filed: Jan. 15, 2013

Related U.S. Application Data
(63) Continuation-in-part of application No. 13/336,515, filed on Dec. 23, 2011, now abandoned.
(60) Provisional application No. 61/743,153, filed on Aug. 27, 2012.

(51) Int. Cl. E05B 65/00

(52) U.S. Cl. CPC E05B 65/006
USPC 70/158

(57) ABSTRACT

In some embodiments, a locking cap system useful for controlling access to a gaseous system includes an outer cap, an inner lock, a metallic key and a magnetic opener. The inner lock rotates freely relative to the outer cap and is releasably engaged with the gaseous system. The metallic key is configured to be at least partially axially movable within the inner lock and the outer cap. The magnetic opener is useful to bias the metallic key so that the metallic key engages the inner lock and the outer cap simultaneously to allow the inner lock to rotate concurrently with rotation of the outer cap and engage or disengage from the gaseous system.

### CROSS REFERENCE TO RELATED APPLICATIONS

This application is a continuation-in-part application of and claims priority to U.S. patent application Ser. No. 13/336,515 filed on Dec. 23, 2011, entitled “Apparatus and Methods for Restricting Access to a Gas Source”, which application claims priority to U.S. Provisional Patent Application Ser. No. 61/575,837 filed on Aug. 30, 2011, both applications of which are hereby incorporated by reference herein in their entireties. This application also claims priority to U.S. Provisional Patent Application Ser. No. 61/743,153 filed on Aug. 27, 2012, which is hereby incorporated by reference herein in its entirety.

### FIELD OF THE INVENTION

The present disclosure relates generally to gas access technology, more particularly, to apparatus and methods for restricting easy access to a gas source.

### BACKGROUND OF THE INVENTION

Various systems include gasses that are useful or necessary, but may be harmful to humans if inhaled in particular concentrations. Consequently, it may be undesirable to allow easy access to gases utilized in many types of systems.

Over the years, there has been evidence of people intentionally inhaling potentially dangerous gases having an otherwise meaningful or necessary use. For example, children and young adults have been known to tap into refrigerant lines of air conditioning systems to inhale Freon in order to get “high”. Access is often easy, for example, in systems utilizing a “Schrader” valve, which is commonly included to be able to adjust refrigerant levels. In a typical Schrader valve system, refrigerant can be added or released by simply unscrewing a threaded cap to gain access to the center pin of the Schrader valve. The pin is then depressed to inject or expel the gas. These threaded caps are normally included to cover and protect the center pin from damage, but do not restrict unauthorized access to the valve and gas. To limit easy access to compressed refrigerant gasses in air conditioning systems, some local jurisdictions in the U.S. have enacted legislation, regulations or code requirements requiring an effective locking mechanism on the refrigerant access points.

Presently known technologies for preventing or limiting easy or unauthorized access to gas sources or other items may have one or more drawbacks. For example, protective cap devices have been developed for restricting access into containers, such as medicines or poisons. Some of these tamper resistant caps require only that the cap be depressed slightly while rotating the cap. Other more complex caps require the use of a key that can either complicate the process of opening the cap or are easily bypassed. Some examples of prior art patents in this area include U.S. Pat. Nos. 6,032,811, 3,426,932 and 738,917.

Prior art in the field of refrigerant caps includes a product called Novent. This product is designed to restrict unauthorized access to the refrigerant port of a Schrader valve. The Novent product is described in U.S. Pat. No. 6,612,455, which sets forth a cap having an outer cover that spins freely around an inner lock to prevent access to the Schrader valve. The outer cap has a keyhole leading into a recessed cavity of the inner lock. A key is inserted to allow access to the Schrader valve. When the key is turned, a tab pivotally abuts an annular flange causing the inner lock to be wedged against the outer cap. However, this locking mechanism may have disadvantages. For example, adhesives or abrasive materials can be inserted into the keyhole to effectively connect the inner lock and outer cap, allowing easy access to the Schrader valve by simply turning the outer cap. For another example, because this device requires friction, the cap assembly cannot usually be tightly (i.e. wrench tight) fitted onto the valve, thus allowing it to be removed. For yet another example, the internal “wedge” design of this assembly is complex and must be almost perfectly aligned in order to function, requiring the cap assembly to be manufactured with tight tolerances, resulting in high manufacturing costs and significant failure and quality control concerns.

It should be understood that the above-described discussion is provided for illustrative purposes only and is not intended to limit the scope or subject matter of the appended claims or those of any related patent application or patent. Thus, none of the appended claims or claims of any related application or patent should be limited by the above discussion or construed to address, include or exclude each or any of the cited examples, features and/or disadvantages, merely because of the mention thereof herein.

Accordingly, there exists a need for improved systems, apparatus and methods useful to assist in restricting access to gas sources having one or more of the following attributes or capabilities, or one or more of the attributes or capabilities described or shown in, or as may be apparent from, the other portions of this patent: provides a cap lock system that includes both a locking mechanism and a lock release mechanism for restricting access to a gas source; is useful for restricting access to a gas access port; is useful for restricting access to a Schrader valve used to access a gas container or source; restricts access to the threaded end of a Schrader valve used to access refrigerant in residential or commercial air conditioning systems; does not have openings in which friction producing materials (e.g. sand) may be inserted to disable the access-limiting capability; includes a cap lock system having a cap lock that may be suitably tightened over the gas access port without damaging the cap lock system; includes a cap lock system that is easier to manufacture, has less parts or less stringent tolerances as compared to prior technology; or any combination thereof.

### BRIEF SUMMARY OF THE DISCLOSURE

In some embodiments, the present disclosure involves a locking cap system useful for controlling access to a gaseous system. The locking cap system includes an outer cap, an inner lock, a metallic key and a magnetic opener. The inner lock rotates freely relative to the outer cap and is releasably engaged with the gaseous system. The metallic key is configured to be at least partially axially movable within the inner lock and the outer cap. The magnetic opener is useful to bias the metallic key so that the metallic key engages the inner lock and the outer cap simultaneously to allow the inner lock to rotate concurrently with rotation of the outer cap and engage or disengage from the gaseous system.

In various embodiments, the present disclosure involves an apparatus useful for restricting access to a gas source. The apparatus includes an outer cap having upper and lower ends and a main cavity extending from an opening at the lower end. The main cavity has a reduced diameter portion proximate to the upper end of the outer cap. An inner lock includes upper and lower ends and an upper cavity extending from an opening at the upper end. The inner lock is configured to releasably engage the gas source at its lower end and be inserted into and rotatable within the main cavity of the outer cap. A metallic key is disposed entirely within the upper cavity of the inner lock in a first position and moveable axially partially into the reduced diameter portion of the main cavity of the outer cap in a second position. In the second position, the metallic key is disposed partially within the inner lock and partially within the outer cap.

In the first position of the metallic key, the inner lock is not rotatable upon rotation of the outer key sufficient to disengage the inner lock from the gas source. However, in the second position of the metallic key, the inner lock is rotatable upon rotation of the outer key sufficient to disengage the inner lock from the gas source. A magnetic opener is positionable at least partially over the outer cap and configured to bias the metallic key into the second position, allowing the inner lock to rotate upon rotation of the outer cap and disengage from the gas source.

In many embodiments, the present disclosure involves a method of restricting access to a gas source with the use of a cap lock system having an outer cap, an inner lock and a metallic key. The outer cap has at least one cavity and at least one recess. The inner lock has at least one cavity and is configured to be inserted into and rotatable within a cavity of the outer cap. The inner lock is also releasably engageable with the gas source. The metallic key is disposed and non-rotatable within a cavity of the inner lock and axially moveable at least partially into a recess of the outer cap. The metallic key is also non-rotatable within the recess. The method includes engaging the gas source with the lower end of the inner lock. A magnetized device is placed proximate to the outer cap. The magnetized device causes the metallic key to move into a position so that it is partially disposed within a cavity of the inner lock and a recess of the outer cap. The outer cap is rotated sufficient to cause the inner cap to rotate and disengage from the gas source.

Accordingly, the present disclosure includes features and advantages which are believed to enable it to advance gas access technology. Characteristics and advantages of the present disclosure described above and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description herein:

FIG. 1 is an exploded view of an apparatus for restricting access to a gas source including an exemplary inner lock, outer cap, spring-like shifter and opening device in accordance with an embodiment of the present disclosure;

FIG. 2 is a cross-sectional view of the embodiment of FIG. 1 showing the exemplary opening device not in contact with the exemplary outer cap;

FIG. 3 is a cross-sectional view of the embodiment of FIG. 1 showing the exemplary opening device disposed over the exemplary outer cap;

FIG. 4 is a cross-sectional view of another embodiment of an apparatus for restricting access to a gas source having a flexor-like shifter;

FIG. 5 is a cross-sectional view of another embodiment of an apparatus for restricting access to a gas source having a magnetic shifter;

FIG. 6 is an assembly drawing of an exemplary outer cap and gas type indicator of an embodiment of an apparatus for restricting access to a gas source in accordance with the present disclosure;

FIG. 7 is a perspective view of the exemplary gas type indicator shown engaged with the exemplary outer cap of FIG. 6; and

FIG. 8 is a cross-sectional view of the exemplary gas type indicator and outer cap of FIG. 7 taken along lines 8-8.

### DETAILED DESCRIPTION OF PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Many changes may be made to the particular embodiments and details disclosed herein without departing from such spirit and scope.

In showing and describing preferred embodiments in the appended figures, common or similar elements are referenced with like or identical reference numerals or are apparent from the figures and/or the description herein. The figures are not necessarily to scale and certain features and certain views of the figures may be shown exaggerated in scale or in schematic in the interest of clarity and conciseness.

As may be used herein and throughout various portions (and headings) of this patent application, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. The terms “coupled”, “connected”, “engaged” and the like, and variations thereof, as used herein and in the appended claims are intended to mean either an indirect or direct connection or engagement. Thus, if a first device couples to a second device, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . ” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

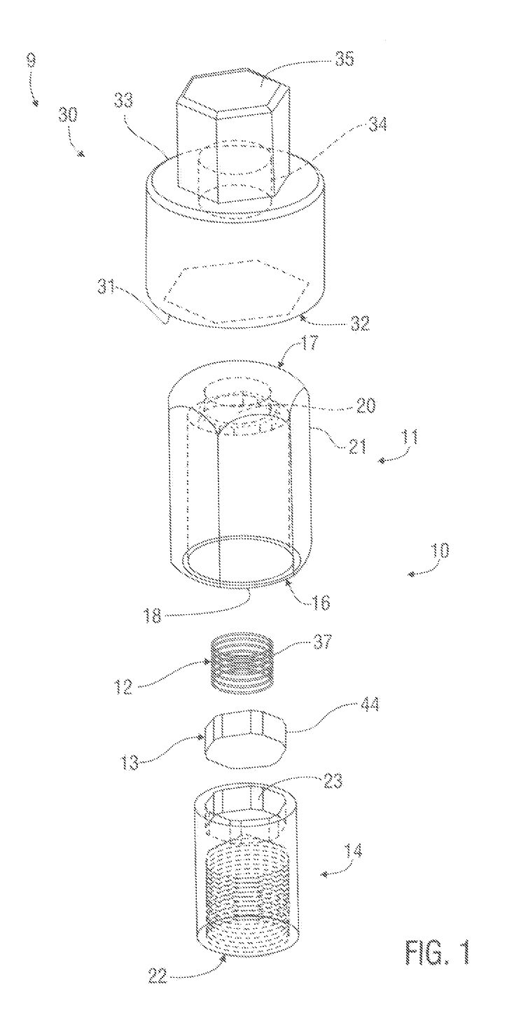

Referring initially to the embodiment of FIG. 1, an example cap lock system 9 includes a cap lock 10 and a magnetic opener 30. The illustrated cap lock 10 includes an outer cap 11, shifter 12, key 13 and inner lock 14.

In this embodiment, the outer cap 11 is generally cylindrically shaped and has an exterior surface 21 shaped to allow the outer cap 11 to be gripped by the magnetic opener 30 (e.g. hexagonal) for rotation thereof. The outer cap 11 also includes a generally cylindrically-shaped main cavity 16 and an opening 18 into the cavity 16. The illustrated main cavity 16 and opening 18 are sized so that the inner lock 14 can slide into the outer cap 11 and fit snugly inside the main cavity 16. In this particular embodiment, the inner lock 14 fits inside the main cavity 16 without friction between the outer surface of the inner lock 14 and the inner surface of the outer cap 11 (i.e. the surface defining the cavity 16). The illustrated outer cap 11 has a closed distal end 17 opposite the opening 18. Depending upon the application, the outer cap 11 may be constructed of any suitable material or combination of materials, such as, for example, stainless steel, aluminum or molded plastic and may be manufactured by any suitable process, such as machining, casting, stamping or molding.

Still referring to the embodiment of FIG. 1, the main cavity 16 of the outer cap 11 includes one or more recesses, or reduced diameter portions 20, shaped to house at least part of one or more shifters 12 and/or one or more keys 13. In this particular example, as shown in FIG. 2, first and second reduced diameter portions 20a and 20b are included. The exemplary first reduced diameter portion 20a of the main cavity 16 provides a biasing face 36 (see FIGS. 2 & 3) for the illustrated shifter 12, which is a single coil spring 37. The illustrated second reduced diameter portion 20b of the main cavity 16 is sized to accept only a portion of the key 13 and shaped (e.g. hexagonal) to mate with the key 13 sufficient to prevent independent rotation of the outer cap 11 relative to the key 13, and vise versa. However, one or more reduced diameter portion(s) 20 may have any other suitable arrangement and configuration and are not necessary or required in all embodiments.

The illustrated inner lock 14 is also generally cylindrically shaped and includes upper and lower cavities 23, 22. The inner lock 14 is configured to engage the gas source (not shown) at the lower cavity 22. In this example, the lower cavity 22 is threaded for threaded engagement with the gas source (not shown), such as the internally threaded portion of a Schrader or other gas access port, valve or other component associated with a gaseous system or gas container.

The upper cavity 23 of the inner lock 14 is sized to house the entire key 13, which is axially moveable therein, and shaped (e.g. hexagonal) to mate with the key 13 sufficient to prevent independent rotation of the inner lock 14 relative to the key 13, and vise versa. Depending upon the application, the inner lock 14 may be constructed of any suitable material or combination of materials, such as, for example, stainless steel, aluminum or molded plastic and may be manufactured by any suitable process, such as machining, casting, stamping or molding.

In this example. the key 13 is a single metallic button 44 having a hexagonal outer shape, which mates with the shape of the walls of the second reduced diameter portion 20b of the main cavity 16 and the upper cavity 23 of the inner lock 14. However, the key 13 may have any other suitable form, configuration and construction. For example, in some embodiments, the key 13 may include one or more permanent magnets. Due to the arrangement of the exemplary key 13 inside the inner lock 14 and outer cap 11, the key 13 will not inhibit a user from torquing the cap lock 10 tightly against the gaseous access control port (e.g. Schrader valve) for secure engagement therewith without significant risk of damaging the cap lock 10.

As mentioned above, the illustrated shifter 12 is a single coil spring 37. However, the shifter 12 may have any other suitable form, configuration and construction. For example, the shifter 12 may include one or more other type of spring(s) or biasing member(s) constructed of any suitable material(s), such as metal, elastomer or a combination thereof that is capable of biasing the key 13 entirely into the inner lock 14 and allowing the key 13 to move axially in the opposite direction into the outer cap 11. In FIG. 4. for example, the illustrated shifter 12 is a flexor 38, such as a hollow or solid dome-shaped or cylindrical member constructed at least partially elastomeric material. Examples of potentially suitable elastomeric materials used in the flexor 38 are Thermo Plastic Elastomers (TPE), such as SantoPrene material from Exxon. If desired, the flexor 38 (or other form of shifter 12) may include shape-memory material, such as shape-memory alloy(s) or polymer(s). The flexor 38, like the coil spring 37, is capable of (i) biasing the key 13 entirely into the upper cavity 23 of the inner lock 14, (ii) compressing so that the key 13 can move at least partially into a reduced diameter portion 20 of the main cavity 16 of the outer cap 11 and (iii) moving back and forth between these states.

For another example, FIG. 5 shows a shifter 12 that includes at least one magnet 40 disposed within the inner lock 14. The magnet(s) 40 may have any suitable form, configuration and construction and may be provided in the inner lock 14 in any suitable manner. For example, the magnet(s) 40 may be embedded or inserted into, or formed integrally with, the inner lock 14, or the inner lock 14 may be constructed at least partially of magnetic material. The magnet 40 will draw or pull the key 13 fully into the upper cavity 23 of the inner lock 14, but has a magnetic force that is weaker that the magnetic force of the magnetic opener 30 (described below). So when the magnetic opener 30 is placed over the outer cap 11, as will be described further below, it will overstrength the magnetic forces of the magnet 40 and pull the key 13 partially into a reduced cavity portion 20 of the main cavity 16 of the outer cap 11. It should be noted that in this particular arrangement, the reduced diameter portion 20 of the main cavity 16 of the outer cap 11 does not house the shifter 12 (magnet 40). However, in some embodiments, two or more different types of shifters 12 may be used, such as a magnet 40 in the inner lock 14 and a coil spring 37, flexor 38 or other biasing member disposed at least partially within a reduced diameter portion 20 of the main cavity 16 of the outer cap 11.

Referring again to the embodiment of FIG. 1, the illustrated cap lock 10 is assembled by first placing the shifter 12 (e.g. coil spring 37) into the main cavity 16 of the outer cap 11 followed by the key 13, which is followed by the inner lock 14. In this example, the main cavity 16 completely encapsulates the sides of the inner lock 14 so that the inner lock 14 cannot be directly gripped and rotated independent of the outer cap 11. Since there is no externally accessible key hole opening in the exemplary outer cap 11, it would be difficult to disable the cap lock 10 (to allow access to the refrigerant source) by inserting adhesive or abrasive materials into a space between inner lock 14 and the outer cap 11.

The exemplary inner lock 14 may be retained within the main cavity 16 in any suitable manner. For example, the inner lock 14 may be retained within the cavity 16 with the use of one or more clips (not shown) that do not significantly impede the independent rotation of the outer cap 11 and inner lock 14. For another example, after the inner lock 14 is placed inside the cavity 16, the opening 18 of the outer cap 11 may be reshaped to retain the inner lock 14 inside the cavity 16 by any suitable technique, such as by crimping, bending, compressing or striking (e.g. swedging with a hammer), but without significantly impeding the independent rotation of the outer cap 11 and inner lock 14. For yet another example, the inner lock 14 and outer cap 11 may have mating features or mechanisms (not shown) that axially retain the inner lock 14 in the outer cap 11, but allow their independent rotation.

Still referring to the example of FIG. 1, the illustrated magnetic opener 30 is also generally cylindrically shaped and includes at least one engagement cavity 32 and an opening 31 thereto. However, the magnetic opener 30 may have any other suitable form and configuration and may be any suitable magnetized device useful to cause the key 13 to move at least partially from the inner lock 14 into the outer cap 11. Also, it should be noted that while the exemplary opener 30, inner lock 14 and outer cap 11 have been described as being generally cylindrically shaped, they may have any other suitable form, shape and configuration. Depending upon the application. the magnetic opener 30 may be constructed of any suitable material or combination of materials, including, for example, stainless steel, aluminum or molded plastic and may be manufactured by any suitable process, such as machining, casting, stamping or molding.

The engagement cavity 32 of the illustrated opener 30 is shaped to fit over and engage, or grip, the exterior surface 21 of the outer cap 11 so that rotation of the opener 30 over the outer cap 11 will cause rotation of the outer cap 11. In this example, the exterior surface 21 of the outer cap 11 has a hexagonal shaped and the inner surface of the cavity 32 has a mating hexagonal shape. However, any suitable mating arrangement may be used so long as the opener 30 can be used to fit over and rotate the outer cap 11 for embodiments that include this feature. For example, a variety of irregular mating shapes may be used, such as polygonal or oval shapes. For another example, the outer cap 11 may include one or more protrusions (not shown) on the exterior surface 21. Such protrusion(s) could mate with one or more correspondingly-shaped part of the engagement cavity 32 of the opener 30, such as to help prevent a magnet not associated with magnetic opener 30 from magnetically communicating with the metallic key 13.

Still referring to the embodiment of FIG. 1, the magnetic opener 30 may be magnetized in any suitable manner. In this example, the end portion 33 of the opener 30 includes a single magnet 34 proximate to the upper end of the engagement cavity 32, which may be provided in any suitable manner. For example, the magnet 34 may be embedded in, integrally formed into or attached to the end portion 33. In other embodiments, multiple magnets 34 may be included, or the end portion 33 (or other portion of the opener 30) may be constructed at least partially of magnetic material. The opener 30 is formed with a magnetic strength that exceeds the biasing force of the shifter 12 sufficient to cause the key 13 to move axially toward the opener 30 and into the outer cap 11 when the opener 30 is placed over the outer cap 11, as will be described further below.

If desired, the magnetic opener 30 may include one or more protrusions 35. The protrusion(s) 35 may be integral with the opener 30 or attached thereto in any suitable manner. The illustrated protrusion 35 is shaped such that it is rotatable by hand or tool to rotate the opener 30. For example, the illustrated protrusion 35 is hexagonally shaped so that it is easily rotatable by wrench. However, other embodiments may not include a protrusion 35, but include an opener 30 that is shaped (e.g. hexagonally) to allow it to be rotated.

Referring now to FIG. 2, the illustrated magnetic opener 30 is shown not in contact with the outer cap 11 and, thus, not in magnetic communication with the key 13. Accordingly, the exemplary shifter 12 is biasing the key 13 fully into the upper cavity 23 of the inner lock 14. In this first position, the key 13 does not extend into the outer cap 11, so the outer cap 11 and inner lock 14 are independently rotatable. Rotation of the outer cap 11 is not translated to the inner lock 14, so the outer cap 11 can be rotated without rotating the inner lock 14. In this first position of the key 13 (without the placement of the magnetic opener 30 over the outer cap 11), a gas source or access port (e.g. Schrader valve) engaged with the inner lock 14 cannot normally be accessed or opened.

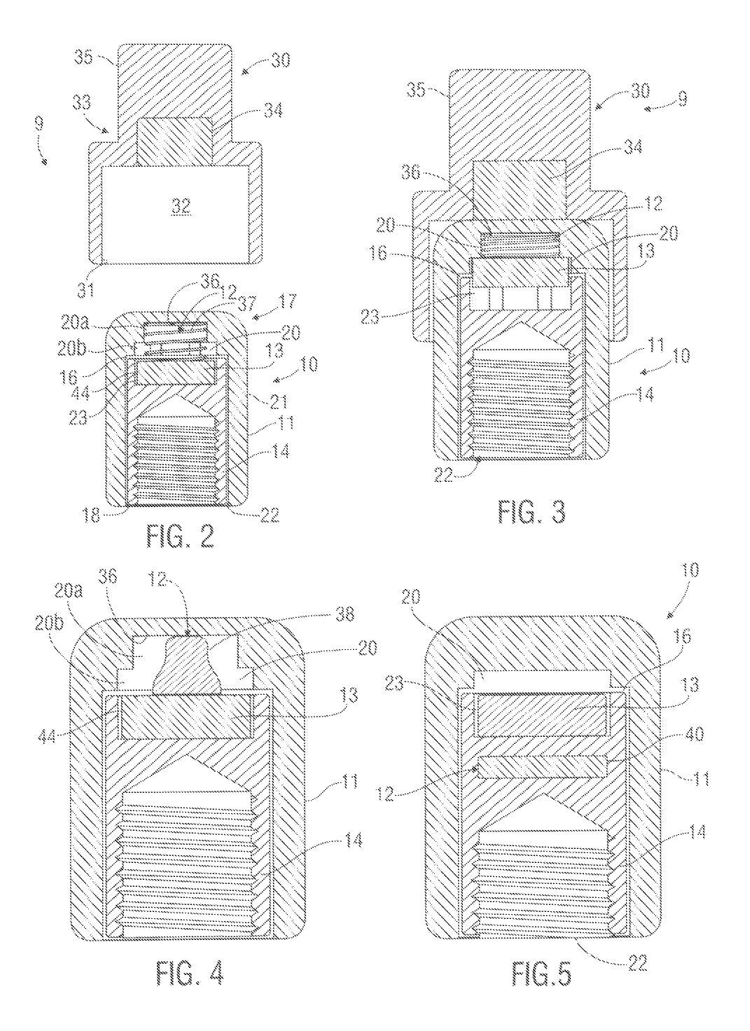

In FIG. 3, the exemplary magnetic opener 30 is shown slid over the outer cap 11 and the magnetic opener 30 (e.g. magnet 34) is in magnetic communication with the key 13. Since the opener 30 has a magnetic strength that exceeds the biasing force of the shifter 12, the key 13 has moved axially in the direction of the opener 30. Further, since the reduced cavity portion 20b of the outer cap 11 is sized to accept only a portion of the key 13, the key 13 is shown straddled between the reduced diameter portion 20b and the upper cavity 23 of the inner lock. Yet further, since the key 13 matably engages the reduced diameter portion 20b and the upper cavity 23, the inner lock 14 and outer cap 11 will be concurrently rotatable. Thus, rotation of the illustrated outer cap 11 will cause rotation of the inner lock 14. In this example, sufficient rotation will cause the inner lock 14 to disengage from the attached gas source or access port (e.g. Schrader valve). Thereafter, if desired, the cap lock system 9 of this embodiment may be reused any multitude of times by engagement of a gas source with the inner lock 10 and removal of the exemplary opener 30 from over the outer cap 11 to allow the shifter 12 to position the key 13 back to its first position, as described earlier.

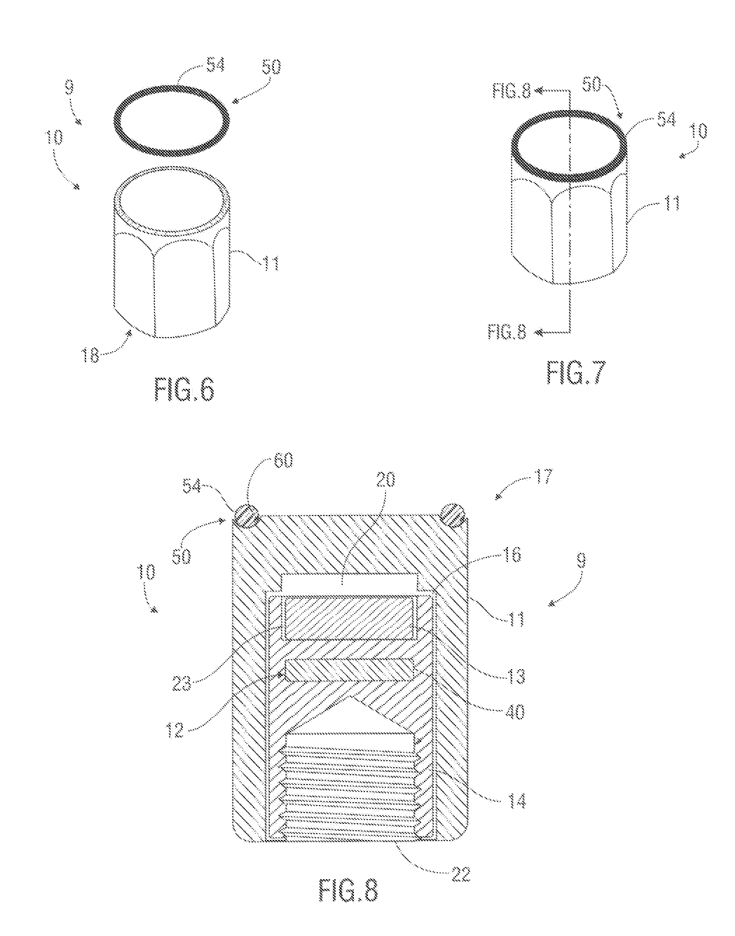

Now referring to FIGS. 6-8, if desired, the cap lock system 9 may include a gas type indicator 50 to indicate the type of gas that is provided in the gas source (not shown). The gas type indicator 50 may have any suitable form, configuration and operation, as long as it indicates the type of gas in the gas source (not shown) with which the cap lock system 9 is used. For example, the gas type indicator 50 may have an adjustable color setting or gas identifier (e.g. by name), such as a slide display, that can be manually set when connecting the cap lock 10 to a gas source.

For another example, in the illustrated embodiment, the gas type indicator 50 is a colored ring 54 that is releasably engageable with the outer cap 11 and clearly visible when the cap lock 10 is used with a gas source (not shown). For example, the colored ring 54 may be snapped into a groove 60 formed around the distal end 17 of the outer cap 11. The colored ring 54 may be plastic, metal or constructed of any other suitable material.

In this embodiment, multiple colored rings 54 may be used with the cap lock system 9, each ring 54 bearing or displaying a different color according to a color guide or index that corresponds each color with a different type of gas. Any suitable or desirable color coding may be used. The user can thus select the appropriate ring 54 to identify the type of gas being covered with the illustrated cap lock 10. Accordingly, when the exemplary cap lock 10 is used with a gas source (not shown) holding a particular type of gas, the appropriate colored ring 54 is simply snapped onto the outer cap 11. Later, if the illustrated outer cap 11 is used with a gas source (not shown) containing a different type of gas, the colored ring 54 can simply be switched.

In yet other exemplary embodiments, the gas type indicator 50 may include a replaceable tab (not shown), or any other shaped and configured member, that indicates the type of gas in the gas source and is removably slid or snapped into an appropriate keeper (not shown) in the outer cap 11. Thus, the form of the gas type indicator 50 or the technique by which it indicates the type of gas in the gas source is not limiting upon the present disclosure.

Preferred embodiments of the present disclosure thus offer advantages over the prior art and are well adapted to carry out one or more of the objects of this disclosure. However, the present invention does not require each of the components and acts described above and is in no way limited to the above-described embodiments, methods of operation, variables, suggested shapes, values or value ranges. Any one or more of the above components, features and processes may be employed in any suitable configuration without inclusion of other such components, features and processes. Moreover, the present invention includes additional features, capabilities, functions, methods, uses and applications that have not been specifically addressed herein but are, or will become, apparent from the description herein, the appended drawings and claims.

The methods that may be described above or claimed herein and any other methods which may fall within the scope of the appended claims can be performed in any desired suitable order and are not necessarily limited to any sequence described herein or as may be listed in the appended claims. Further, the methods of the present invention do not necessarily require use of the particular embodiments shown and described herein, but are equally applicable with any other suitable structure, form and configuration of components.

While exemplary embodiments of the invention have been shown and described, many variations, modifications and/or changes of the system, apparatus and methods of the present invention, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the invention and scope of appended claims. Thus, all matter herein set forth or shown in the accompanying drawings should be interpreted as illustrative, and the scope of the disclosure and the appended claims should not be limited to the embodiments described and shown herein.

1. A locking cap system for controlling access to a gaseous system, the locking cap system comprising:
an outer cap;
an inner lock that rotates freely relative to said outer cap and is releasably engaged with the gaseous system;
a metallic key configured to be at least partially axially movable within said inner lock and said outer cap;
a gas type indicator releasably engageable with said outer cap and configured to indicate the type of gas disposed in the gas source; and
a magnetic opener useful to bias said metallic key so that said metallic key engages said inner lock and said outer cap simultaneously to allow said inner lock to rotate concurrently with rotation of said outer cap and be engaged or disengaged from the gaseous system.

2. The locking cap system of claim 1, wherein said inner lock has a cavity to accept said metallic key and said outer cap has a cavity that can accept at least part of said metallic key.

3. The locking cap system of claim 2, wherein said cavity in said inner lock is sized so that said metallic key can fit entirely therein and said cavity in said outer cap is sized so that only a portion of said metallic key fits therein.

4. The locking cap system of claim 3, further comprising a shifter that biases said metallic key into said cavity of said inner lock.

5. The locking cap system of claim 4, wherein said magnetic opener is configured to overcome the biasing force of said shifter sufficient to position said metallic key so that it simultaneously extends partially into both said cavity of said outer cap and said cavity of said inner lock, allowing rotation of said inner lock upon rotation of said outer cap.

6. The locking cap system of claim 5, wherein said shifter includes at least one among at least one spring and at least one magnet.

7. The locking cap system of claim 5, wherein said shifter is constructed at least partially of elastomeric material.

8. The locking cap system of claim 5, wherein the outer surface of said outer cap is configured to mate with a cavity of said magnetic opener and said magnetic opener is configured so that it must be engaged over said outer cap in order to overcome the biasing force of said shifter.

9. Apparatus useful for restricting access to a gas source, the apparatus comprising:
an outer cap having upper and lower ends and a main cavity extending from an opening at said lower end of said outer cap, said main cavity having a reduced diameter portion proximate to said upper end of said outer cap;
an inner lock having upper and lower ends and an upper cavity extending from an opening at said upper end of said inner lock, said inner lock being configured to releasably engage the gas source at said lower end and be inserted into and rotatable within said main cavity of said outer cap;
a metallic key disposed entirely within said upper cavity of said inner lock in a first position and moveable axially partially into said reduced diameter portion of said main cavity of said outer cap in a second position, wherein said metallic key in said second position is disposed partially within said inner lock and partially within said outer cap, wherein in said first position of said metallic key, said inner lock is not rotatable upon rotation of said outer key sufficient to disengage said inner lock from the gas source, and in said second position of said metallic key, said inner lock is rotatable upon rotation of said outer key sufficient to disengage said inner lock from the gas source; and
a magnetic opener positionable at least partially over said outer cap and configured to bias said metallic key into said second position when positioned at least partially over said outer cap, allowing said inner lock to rotate upon rotation of said outer cap and disengage from the gas source.

10. The apparatus of claim 9, further including a shifter configured to bias said metallic key into said first position.

11. The apparatus of claim 10, wherein said magnetic opener is configured to overcome the biasing forces of said shifter sufficient to bias said metallic key into said second position.

12. The apparatus of claim 10, wherein said shifter includes at least one metallic spring.

13. The apparatus of claim 10, further including a gas type indicator associated with said outer cap and configured to indicate the type of gas disposed in the gas source.

14. The apparatus of claim 13, wherein said shifter is dome-shaped.

15. The apparatus of claim 10, wherein said shifter includes at least one magnet disposed within said inner lock.

16. The apparatus of claim 9, wherein said magnetic opener is configured to at least partially engage the outer surface of said outer cap so that said outer cap is rotatable upon rotation of said magnetic opener, whereby engagement of said magnetic opener at least partially over said outer cap and rotation of said magnetic opener causes access to the gas source.

17. A method of restricting access to a gas source with the use of a cap lock system, the cap lock system having an outer cap with at least one cavity and at least one recess, an inner lock having at least one cavity and configured to be inserted into and rotatable within a cavity of the outer cap, the inner lock being releasably engageable with the gas source, a metallic key disposed and non-rotatable within a cavity of the inner lock and axially moveable at least partially into, and non-rotatable within, a recess of the outer cap, the method comprising:
engaging the gas source with the lower end of the inner lock;
placing a magnetized device proximate to the outer cap;
the magnetized device causing the metallic key to move into a position partially disposed in a recess of the outer cap and a cavity of the inner lock; and
rotating the outer cap sufficient to cause the inner cap to rotate and disengage from the gas source.

18. The method of claim 17 wherein the magnetized device is a magnetic opener positionable at least partially over the outer cap, further including rotating the magnetic opener to rotate the outer cap.

19. The method of claim 18 further including removing the magnetic opener from over the outer cap, causing the metallic key to move entirely into a cavity of the inner lock and out of any cavity in the outer cap to prevent rotation of the inner lock upon rotation of the outer cap.

20. The method of claim 17 further including engaging a gas type indicator with the outer cap to indicate the type of gas disposed in the gas source
